(19) United States
(12) Patent Application Publication
(10) Pub. No.: US 2024/0210350 A1
(43) Pub. Date: Jun. 27, 2024

(54) SELECTIVE CHEMICAL SENSOR

(71) Applicant: Government of the United States as Represented by the Secretary of the Air Force, Wright-Patterson AFB, OH (US)

(72) Inventors: Steve S Kim, DAyton, OH (US); Rajesh Naik, Centerville, OH (US); Claude C Grigsby, Beavercreek, OH (US); Jennifer A. Martin, Beavercreek, OH (US); Michael Brothers, Lebanon, OH (US); Yen H Ngo, Springfield, OH (US)

(73) Assignee: Government of the United States as Represented by the Secretary of the Air Force, Wright-Patterson AFB, OH (US)

(21) Appl. No.: 18/423,977

(22) Filed: Jan. 26, 2024

Related U.S. Application Data
(63) Continuation of application No. 16/203,663, filed on Nov. 29, 2018.

(51) Int. Cl. G01N 27/414

(52) U.S. Cl. CPC G01N 27/4141; G01N 27/4146

(57) ABSTRACT

Disclosed is a selective chemical sensor, methods of production, and methods of use, where the sensor utilizes an electrochemical sensor element protected by a semi-selective polymeric matrix in conjunction with a selecting compound doped into the matrix along with an acid or base. The polymeric matrix serves as an analyte capture matrix, while the selecting compound reacts with the analyte, further improving the selectivity of the sensor.

This application is a continuation of U.S. application Ser. No. 16/203,663 filed Nov. 29, 2018, the contents of which is expressly incorporated herein by reference in its entirety.

### RIGHTS OF THE GOVERNMENT

The invention described herein may be manufactured, used, and/or licensed by or for the United States Government.

### FIELD OF THE INVENTION

The invention is related to a selective chemical sensor and methods for using or producing the sensors, and specifically to a chemical sensor utilizing carbon nanotube sensing elements with semi-selective polymeric matrices and selecting compounds for reacting with an analyte.

### BACKGROUND OF THE INVENTION

The degree of exposure to volatile organic compounds, gases, and air-borne particles among human subjects can significantly vary significantly due to his or her differences in work, recreational, and residential settings. Personal data from medical records; profiles of the patient's genes, metabolites, and microorganisms in and on the body; environmental and lifestyle data; patient-generated information; and personal device and sensor data may all play key roles in finding the right preventive, diagnostic, and treatment tools for disease in conjunction with Big Data and cloud-based computing.

As an example, one particular compound, isopropyl alcohol (IPA), is a main component of many commercially available chemical products, including as a de-icer spray for commercial/non-commercial aircraft. PA has the potential to contaminate flight breathing air due to accumulation/evaporation in the airplane structure during or pre/post flight. Moreover, IPA has been shown to act as an anesthetic and central nervous system depressant, resulting in symptoms that can diminish the cognitive ability of the individual. Thus, it is imperative to be able to monitor, e.g., IPA content and accumulative exposure level. However, commercial alcohol sensors do not fit the requirement for selective IPA sensing, as they are 1) are bulky, 2) suffer from sensor drift, 3) are chemically unstable, 4) require optical/electrical components (cost/size), and/or 5) have a slow response time.

Therefore, a noiseless, low-powered and selective sensing platform for wearable or attachable personal air-quality monitors is desirable.

### SUMMARY OF THE INVENTION

A selective chemical sensor is disclosed. The sensor has an electrochemical sensor element, which changes resistance as a function of ion content, concentration, or both, connecting at least two electrodes. The electrochemical sensor element is in contact with a semi-selective polymeric matrix that contains a catalyst for promoting reaction of an analyte, and a selecting compound within the semi-selective polymeric matrix capable of reacting with the analyte.

The sensor may also include a substrate in contact with the electrodes and the electrochemical sensor element. The analyte may be a volatile organic compound (VOC), and more particularly the analyte may be isopropyl alcohol (IPA). In other cases, it may be a semi-volatile compound such as, e.g., tricresol phosphate or other cresyl/cresol phosphate.

Advantageously, the semi-selective polymeric matrix may have a thickness of less than 25 nm, and in some cases may consist of a water-soluble polymer. The polymeric matrix may be comprised of a single monomer, of co-polymers, or of layers of polymers. Monomeric building blocks may be, but are not limited to the following: N-vinylpyrrolidone, acrylic acid, vinyl alcohol, styrene, cyclic olefins, etc. Polymer selection depends on the specific gaseous compound, i.e. analyte, that is to be detected.

The electrode contacts to the sensing element may advantageously comprise Au, but may also be of any highly conductive material, including but not limited to Pt, Ag, Cu, Ru, Ir, and other materials. Advantageously, the electrochemical sensor element comprises a plurality of single wall carbon nanotubes (SWCNT), but may also comprise other 2D materials such as, but not limited to, graphene, MoS₂, and WSe₂.

Advantageously, the selecting compound may comprise a dichromate, a phosphate, perchlorate, and/or a permanganate.

Advantageously, the catalyst may be an acid or base, such as sulfuric acid, hydrochloric acid, or sodium hydroxide, but may also be any compound that enables reactions of the VOC/semi-volatile compound to cause changes in the chemical environment surrounding the sensor. The catalyst may be a base with a pH greater than or equal to 10 or an acid with a pH less than or equal to 4, contained within the semi-selective polymeric matrix.

A method for selectively detecting a chemical is also disclosed. The method involves providing a selective chemical sensor, placing the semi-selective polymeric matrix in contact with a fluid containing an analyte, allowing the analyte to react with the selecting compound, and measuring a resistance across the electrochemical sensor element. The method may also include comparing the measured resistance to a previous measurement or a predetermined threshold. The method may further include generating a signal based on the comparison.

A method of producing a selective chemical sensor is also disclosed. The method involves using dielectrophoresis (DEP) to deposit carbon nanotubes (CNTs) between two electrodes on a substrate. The CNTs are then coated with a semi-selective polymeric matrix. The polymeric matrix is then treated with a mixture that includes a selecting compound and a catalyst, either an acid or base. The DEP step may utilize a voltage between 3 Vₚ₋ₚ and 10 Vₚ₋ₚ, at a frequency between 1 and 100 MHz. The coating process may be controlled such that the semi-selective polymeric matrix is substantially uniform, i.e. 10% maximum variation, and has a thickness of less than 25 nm.

The selecting compound may be a material selected from the group consisting of a dichromate, a phosphate, perchlorate, and a permanganate.

The acid or base may be a material selected from the group consisting of sulfuric acid, hydrochloric acid, and sodium hydroxide.

### BRIEF DESCRIPTION OF THE DRAWINGS

An understanding of the following description will be facilitated by reference to the attached drawings, in which:

FIG. 1A is a block diagram depicting a sectional view of an embodiment of a selective chemical sensor.

FIG. 1B is a block diagram depicting an elevated sectional view of the selective chemical sensor of FIG. 1A.

FIG. 2 is a block diagram depicting an embodiment of a selective chemical sensor system.

FIG. 3 is a flowchart of a method for producing a selective chemical sensor.

FIG. 4 is a flowchart of a method for utilizing a selective chemical sensor.

FIG. 5 depicts the change in resistance of an embodiment of the selective chemical sensor when exposed to three different VOCs.

### DETAILED DESCRIPTION

The embodiments of the invention and the various features and advantageous details thereof are explained more fully with reference to the non-limiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skilled in the art to practice the embodiments of the invention. Accordingly, the examples should not be construed as limiting the scope of the embodiments of the invention.

The terminology used herein is for the purpose of describing particular embodiments only and is not intended to limit the full scope of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element such as an object, layer, region or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Embodiments of the present invention are described herein with reference to cross-section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region or object illustrated as a rectangular will, typically, have tapered, rounded or curved features. Thus, the regions illustrated in the figures are schematic in nature and their shapes are not intended to illustrate the precise shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The disclosed sensor is configured to allow a desired analyte to pass through a doped polymer matrix, wherein a chemical reaction occurs, changing the electrostatic environment around an electrochemical sensing element. This in turn alters the resistance of the sensing element, and a change in resistivity can be detected. In preferred embodiments, the analyte to be detected is a volatile organic compound (VOC), more preferably the analyte is a secondary alcohol, and still more preferably, the analyte is isopropyl alcohol (IPA). In other embodiments, the analyte may be a semi-volatile compound, and more preferably the analyte is cresol phosphate or other cresyl/cresol phosphate.

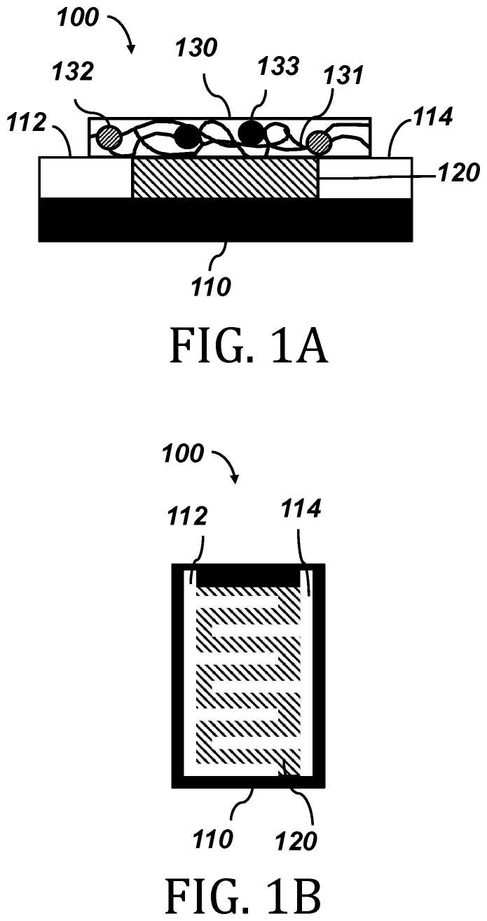

An embodiment of the sensor can be seen in reference to FIGS. 1A and 1B. The sensor (100) is comprised of four basic components.

The first two components can be considered part of a base electronic structure. The base electronic structure begins with a bottom substrate layer (110). The bottom substrate layer (110) is an insulator or dielectric material. One embodiment preferably utilizes a glass substrate. The bottom substrate layer (110) has a top surface upon which interdigitated electrodes (112, 114) are provided. Although any highly conductive material may be used, Pt, Ag, Cu, Ru, Ir, Au, or other commonly used materials will typically be utilized. Preferably the electrodes comprise gold.

Various methods for accomplishing the formation of the electrodes are envisioned, as will be understood by those of skill in the art. For example, a layer of gold could be deposited onto the top surface of the bottom substrate, and then etched to provide the necessary patterning. In other embodiments, a commercially available interdigitated electrode (IDE) that consists of the substrate and electrodes can be utilized. In one example, 28×5 mm glass IDEs with 150 nm thick Au layer, the electrodes being 20 μm wide and having a 10 μm gap, were purchased from NanoSPR, and used as the base electronic structure. The devices were soldered onto a surfboard mount with silver rosin and electrical contacts were made. In another example, a large area substrate (5 cm×15 cm) was utilized.

The third component—an electrochemical sensing element (120)—operably connects the two electrodes (112, 114). The electrochemical sensing element (120) must be able to change resistance as a function of ion content, concentration, or both. FIG. 1A depicts an exemplary cross-section that may appear between any two electrodes, while FIG. 1B depicts a top view of the sensing element (120) being located between the electrodes (112, 114), and on top of the substrate (110). It should be noted that while FIGS. 1A and 1B depict one configuration of the sensing element (120), all that is required is that the sensing element operably connect the two electrodes—the sensing element may be, e.g., provided between the electrodes, over the electrodes, under the electrodes, etc.

These sensing elements (120) may include carbon nanotubes (CNTs), graphene, and transition metal dichalcogenides (TMDs) such as MoS₂, or WSe₂, that have been deposited on the substrate (110) between the electrodes (112, 114).

Preferably, the electrochemical sensing element (120) utilizes carbon nanotubes (CNTs). The CNTs are preferably multiple single wall carbon nanotubes (SWCNTs), and are typically deposited via dielectrophoresis (DEP), although other deposition methods can be utilized.

Single-atom-thin cylindrical semiconductor/semi-metal/metal CNTs change their resistance as a function of ion concentration, doping level, and solvent conditions with unmatched sensitivity compared to bare metal-oxide or inorganic semi-conductors, offering ultimate sensitivity as a nanoelectronic sensors. CNTs often serve as p-type semi-conductors in ambience, and thus their resistance should change as a function of ionic content and/or electrochemical reactions. Thus, the addition of the CNTs creates an electrochemical sensing platform.

The carbon nanotubes in the example device are the main sensing modality; carbon nanotubes exhibit changes in resistance as a function of surface charge density. A consistent methodology for generating SWCNT matrices between the IDEs is imperative for repeatable sensor performance. DEP permits the ability to tune the deposition of SMCNTs as a function of voltage and to create uniform bundles of SWCNTs between the electrodes. In one example, special grade 90% purity SWCNTs with 0.83 nm mean diameter were purchased from Southwest Nanotechnologies (Norman, OK). The SWCNTs were ultrasonicated into a water based suspending medium of PVP and PVP-copolymer solution at 2 wt % concentration. Prior to depositing the CNTs, the solution was carefully left undisturbed to let large CNT bundles settle to the bottom before use. The sensor was then placed in a probe station and electrical contact was made through the Au electrodes. Using the top layer of the PVP-SWCNT suspension, 5 μL was pipetted and the droplet was placed over the area of interest. Process parameters such as frequency of the voltage applied, time of exposure to the AC field, CNT size/length, and solution concentration were studied to determine the suitable parameters needed for deposition of the SWCNTs.

Although preferred embodiments of DEP utilize deposition times between 30 seconds and 10 minutes with a voltage between 3 Vₚ₋ₚ and 10 Vₚ₋ₚ, at a frequency between 1 and 100 MHz, optimal conditions in this example were 60 s deposition time at a frequency of 10 MHz with a peak-to-peak voltage (Vₚ₋ₚ) of 6 V. After the DEP step, the substrates were rinsed with distilled water and then dried with house air.

As an alternative to SWCNTs, for example, graphene or MoS₂ may be deposited as the sensing element (120) using traditional microfabrication methodologies.

More specifically, a positive photoresist may be cast upon the electrodes (112, 114) and lithography techniques known to those with knowledge of the art can be used to remove only those areas of the photoresist exposed to the light source.

CVD of the MoS₂ or graphene is then performed, followed by annealing, and removal of the positive photoresist leaving only the graphene or MoS₂ in the region between the electrodes, producing sensing element (120).

While the electrodes (112, 114) and electrochemical sensing element (120) are functional as a base platform, such a base platform lacks sensitivity to particular analytes. Accordingly, additional elements are needed to provide selectivity.

Referring back to FIG. 1A, the sensor (100) further includes a doped polymer layer (130) that covers the electrochemical sensing element (120) between the two electrodes (112, 114). Typically, the doped polymer layer may also extend over at least a portion of the two electrodes as well.

The doped polymer layer (130) may comprise additional elements. First, the doped polymer layer (130) comprises a semi-selective polymeric matrix (131) that serves as, e.g, an analyte capture matrix Second, the doped polymer layer (130) may comprise a selecting compound (132) that utilizes selective chemistry to improve the selectivity of the doped polymer layer (130).

Solvent semi-selective polymer films have been demonstrated in the gas phase to act as a diffusion barrier for solvatochromic solvent sensors. Both the PAA and PVP coatings may serve as a solvent-selective gate, whereupon only solvents with the correct polarity would reach a colorimetric reagent.

In some embodiments, the semi-selective polymeric matrix comprises of a water-soluble polymer. In other embodiments, the polymeric matrix may be comprised of a single monomer, of co-polymers, or of layers of polymers. Monomeric building blocks may include, but are not limited to, N-vinylpyrrolidone, acrylic acid, vinyl alcohol, styrene, and cyclic olefins. The preferred polymer utilized will depend on the specific compound to be detected. Examples of a polymeric matrix (131) used to coat the electrochemical sensing element (120) may include, but are not limited to, polyvinylpyrrolidone (PVP), polyvinyl alcohol (PVA), Poly(l-vinylpyrrolidone-co-styrene, PVP-PS), Poly(l-vinylpyrrolidone-co-vinyl-acetate, PVP-VA), and Poly(l-vinylpyrrolidone-co-2-dimethylaminoethyl-methacrylate, PVP-DAM).

The thickness of the polymer matrix (131) will necessarily influence performance. Depending on the specific analyte and doped polymer layer (130), a film layer (130) that is too thick may create too large of a diffusion barrier, reducing sensitivity. However, a film layer (130) that is too thin and non-uniform may provide problems with reproducibility, and possibly selectivity/sensitivity if the entire electrochemical sensing element (120) is not coated and/or coated evenly.

Various films were deposited using dip coating. A 0.25 wt % and 0.55 wt % PVP-VA dip-coating resulted in film thicknesses of 35 nm and 53 nm, respectively. Dip-coating the sensor (100) with PVP-DAM, 0.76 wt % resulted in a film thickness of 15 nm and 0.152 wt % with 20 nm. Due to the viscosity of PVP-PS, the majority of the film thicknesses were 75 nm or higher regardless of wt % concentration used. PVP (40 k MW) provided the thinnest uniform coating (15 nm at 0.2 wt % concentration). As expected, higher PVP concentrations resulted in higher film thicknesses. In this example, using PVP with the dip coating technique emerged as the preferred method for producing better film results and sensor response.

Preferably, the thickness of the polymer matrix is less than or equal to 50 nm, more preferably less than or equal to 30 nm, still more preferably less than or equal to 25 nm, and even more preferably less than or equal to 20 nm.

In one example, commercial grade polymer coatings of PVP, PVA, PVP-PS, PVP-VA, and PVP-DAM were all purchased from Sigma Aldrich (St. Louis, MO). Various embodiments were created by dip-coating sensors to cast a polymer film onto the device. In some embodiments, the dip coating was accomplished by hand dipping the sensor into the polymer solution for 10 minutes followed by drying inside a heated vacuum chamber (<60° C.) for five minutes.

Selectivity based solely on polymer absorption of solvent is limited, since many solvents have similar dielectric constants and/or polarities, i.e. one polymer can absorb many solvents. Thus, after the polymer matrix is applied, dopants may then be introduced into the polymer matrix. Dopants may be introduced by various techniques. In one example, after the polymer coating process, a solution containing (400 mg) of Gastec pellets containing potassium dichromate (K₂Cr₂O₇) in distilled water with 1M sulfuric acid (H₂SO₄) was prepared. A sensor was then placed in the solution for 1 minute and then allowed to dry via air.

The particular dopants selected will be those that react with the analyte of interest to change the CNTs' electronic density of states, and thereby create a measurable signal.

In one example, PVP (40 k MW) was doped with a dichromate mixture, found in Gastec pellets, and containing 1 M sulfuric acid. The putative reaction is as follows: 3 CH₃CH(OH)CH₃+K₂Cr₂O₇+4 H₂SO₄→Cr₂(SO₄)₃+3 CH₃(CO)CH₃+7 H₂O+1 K₂SO₄.

From the standpoint of the sensor (100), every IPA molecule absorbed and reacted should decrease the concentration of protons and thus change the electrostatic environment surrounding the electrochemical sensing element (120).

In preferred embodiments, the selecting compound (132) is a dichromate, a phosphate, perchlorate, or a permanganate. For example, dopants, i.e. selecting compounds, may include sodium dichromate, potassium dichromate, or potassium permanganate.

In certain preferred embodiments, the selecting compounds (132) drive an oxidation reaction. In more preferred embodiments, the reaction driven by the dopant (132) converts a secondary alcohol to a ketone.

For example, the chemical oxidation of alcohol is a way of converting alcohol absorption to electron/proton products that change the CNTs' electronic density of states, enabling a measurable sensing signal. In short, hydroxyl functional groups are oxidized first to aldehydes and then sometimes to carboxylic acids in the presence of potassium dichromate, sulfuric acid, and a silver nitrate catalyst. In the case of IPA, which is a secondary alcohol, the reaction can progress only to the ketone, resulting in the generation of acetone, water, and, e.g., chromium sulfate. The net result is a modification of the ion concentration, ion content, and solvent composition that may be exploited for measurement.

As described above, a catalyst (133) may also be utilized. The catalyst may be any compound or combination of compounds that enables reactions of analyte that causes changes in the chemical environment surrounding the sensor.

In certain embodiments, an acid or base may be incorporated into the polymer matrix as the catalyst (133). Typically, these will be bases with a pH greater than or equal to 10 or an acid with a pH less than or equal to 4.

For example, sulfuric acid, hydrochloric acid, or sodium hydroxide may be utilized. Other acids and bases may be appropriate based on the selected polymer, dopants, and analytes.

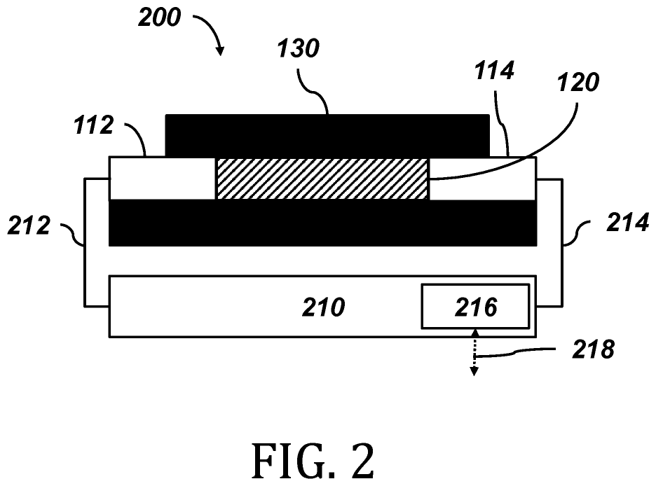

Referring to FIG. 2, a system (200) utilizing the sensor is depicted. An electric circuit (210) may be electrically connected (212) to one of the electrodes (112), and electrically connected (214) to another of the electrodes (114), in order to allow the resistance across the two electrodes (112, 114) and the electrochemical sensing element (120) to be measured. In preferred embodiments, the electric circuit (210) comprises a multimeter, a wheatstone bridge, memory, and/or a processor. In various embodiments, the circuit (210) may also include a communications interface (216) for sending and/or receiving analog or digital signals (218). For example, in some embodiments, the electric circuit includes an ethernet interface for transmitting and receiving digital signals to and from a remote computer.

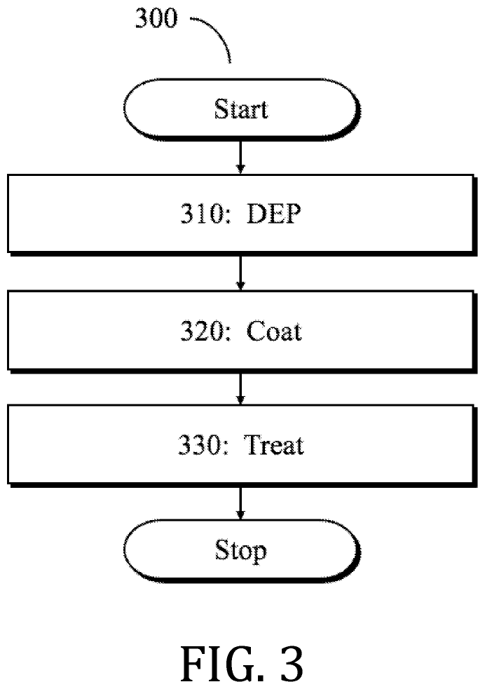

Referring to FIG. 3, a flowchart describing one method for producing a selective chemical sensor (100) is shown. The method (300) begins by utilizing dielectrophoresis (310) to deposit a plurality of carbon nanotubes (120) between two electrodes (112, 114) on a substrate (110). Then, coating (320) at least the carbon nanotubes (120) with a semi-selective polymeric matrix (131). Finally, treating (330) the semi-selective polymeric matrix with a mixture including a selecting compound (132) capable of selectively reacting with an analyte, and a catalyst (133), such as either a base with a pH greater than or equal to 10 or acid with a pH less than or equal to 4.

### Example 1

A 28×5 mm glass IDE with 150 nm thick Au electrodes, the electrodes being 20 μm wide and having a 10 μm gap, were purchased from NanoSPR, and used as the base electronic structure. Special grade 90% purity SWCNTs with 0.83 nm mean diameter were purchased from Southwest Nanotechnologies (Norman, OK). The SWCNTs were ultrasonicated into a water-based suspending medium of PVP and PVP-copolymer solution at 2 wt % concentration. Prior to depositing the CNT, the solution was carefully left undisturbed to let large CNT bundles settle to the bottom before use. The sensor was then placed in a probe station and electrical contact was made through the Au electrodes. Using the top layer of the PVP-SWCNT suspension, 5 μL was pipetted and the droplet was placed over the area of interest. The SWCNTs were deposited via DEP with a 60 s deposition time at a frequency of 10 MHz with a peak-to-peak voltage (Vₚ₋ₚ) of 6 V. After the DEP step, the substrates were rinsed with distilled water and then dried with house air. The sensor was then dip-coated by hand dipping the sensor into a PVP solution (40 k MW at 0.2 wt % concentration) for 10 minutes, followed by drying in a heated vacuum chamber for five minutes, resulting in a 15 nm thick layer. After coating the sensor with PVP, a water based chromic acid solution was prepared by making a solution containing (400 mg) of Gastec pellets containing potassium dichromate (K₂Cr₂O₇) in distilled water with 1M sulfuric acid (H₂SO₄). The devices were then placed in the solutions for 1 minute and then allowed to dry via air.

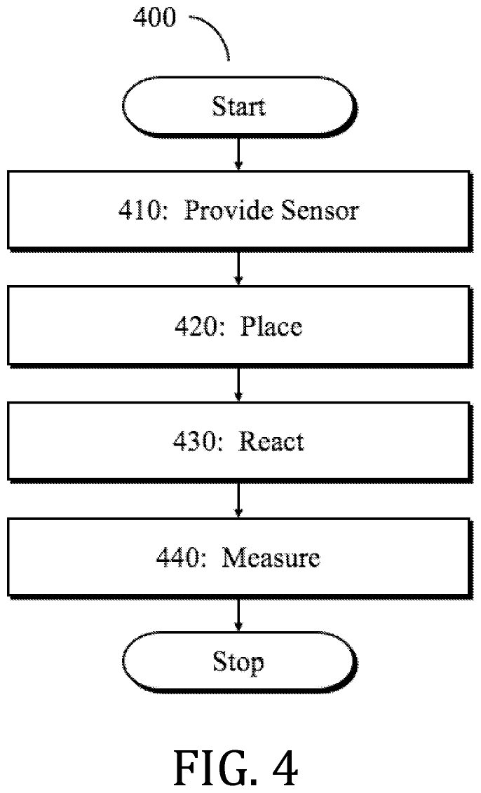

Referring to FIG. 4, a flowchart describing a method for utilizing the sensor is depicted. The method (400) begins by providing (410) an appropriate selective chemical sensor for the analyte of interest. The sensor must then be placed (420) in such a way that the semi-selective polymeric matrix is able to come into contact with a fluid containing the analyte of interest. In some instances, this may be as simple as affixing the sensor to the outside of the user's clothes and exposing the sensor to air around the user. In other instances, this may involve mounting the sensor on a wall.

After placing the sensor, the analyte must be allowed to react (430) with the selecting compound. The electrical resistance is then measured (440) across the electrochemical sensor element. The measurements may be displayed on, e.g., a multimeter, or may be transmitted to a remote computer.

In certain embodiments, the method may also include comparing the measured resistance to a previous measurement or a predetermined threshold. For example, a first resistance measurement (or series of measurements) may be used as a baseline, and if the resistance changes by more than, e.g., 10% from that baseline, a signal may be generated indicating the presence of an analyte of interest. The threshold for how much change is required prior to signaling may vary based on the characteristics of the sensor as will be understood by one of skill in the art. In some instances, a 5% change may be desirable prior to generating a signal. In others, a 200% change may be desirable. In other instances, the resistance measurement may be compared to a particular threshold (typically, a predetermined threshold). For example, if a calibration is performed that correlates resistance with ppm of a particular analyte, and the calibration table is stored in memory in the electric circuit (210), a user may desire to receive a signal (a warning sound, flashing light, a text message, etc.) indicating that a particular concentration of the analyte has been reached. For example, if a user is suddenly exposed to 10,000 ppm of IPA, for example, a light in the sensor system could begin flashing to warn the user of the exposure.

### Example Test Results

Post-characterization, in order to conduct preliminary static vapor experiments, the sensors were placed in custom built chamber (17.43 L) that precisely controls chemical compound concentration, flow rate, and pressure for high concentration exposures. These sensors were mounted onto a breadboard inside of the chamber and electrically connected to a Keithley semiconductor analyzer instrument. The chamber contained a gas inlet/outlet along with a hole for sample injection. The sensors were placed inside of the chamber filled with ambient house air.

Acetone, IPA, and Isoprene were circulated and fed into the static chamber at differing concentrations ranging from 100 ppm to 10000 ppm. Voltage changes were measured in real time with constant current of 1 μA applied to the device terminals and a user specified voltage compliance of 0.5V. In addition, baseline adjustments were completed for each collected data set.

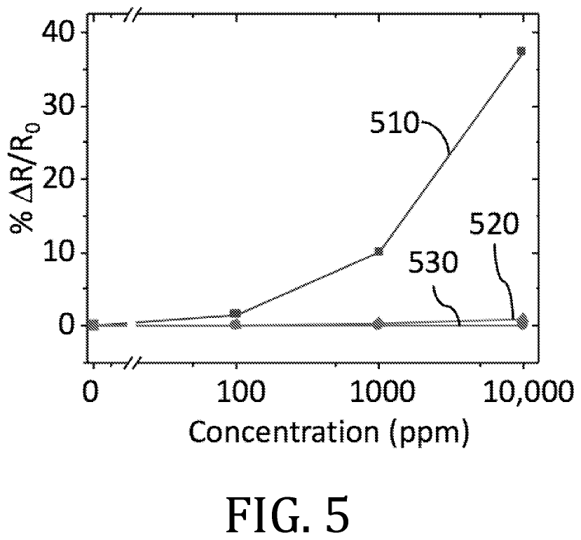

The results from the Example 1 sensor are presented in FIG. 5. As shown, the sensor exhibited a large response change for IPA (510) compared to other VOCS—isoprene (520) and acetone (530)—providing a roughly 40× increase in signal response for IPA (510).

Having thus described a few particular embodiments of the invention, various alterations, modifications, and improvements will readily occur to those skilled in the art. Such alterations, modifications, and improvements as are made obvious by this disclosure are intended to be part of this description though not expressly stated herein and are intended to be within the spirit and scope of the invention. Accordingly, the foregoing description is by way of example only, and not limiting. The invention is limited only as defined in the following claims and equivalents thereto.

What is claimed is:

1. A method for selectively detecting an analyte that is a volatile organic compound (VOC) or a semi-volatile organic compound (SVOC), the method comprising:
operably connecting an electrochemical sensor to at least two interdigitated electrodes, the electrochemical sensor comprising a sensing element and single wall carbon nanotubes (SWCNT), graphene, MoS₂, or WSe₂ and is configured to change resistance as a function of ion content, concentration, or both, the sensing element comprising a highly conductive material;
exposing a doped polymer layer to the electrochemical sensor and the at least two interdigitated electrodes, the doped polymer comprising a semi-selective polymer matrix configured to react with the analyte;
introducing a fluid to the doped polymer layer such that the analyte, if present, reacts with the semi-selective polymer matrix, thereby causing a change ion content, concentration, or both of the electrochemical sensor to change;
with the at least two interdigitated electrodes, measuring a resistance across the electrochemical sensor element; and
based on the measured resistance, determining whether the analyte was in the fluid.

2. The method of claim 1, wherein the doped polymer further comprises a catalyst configured to promote the reaction between the analyte and the semi-selective polymer matrix.

3. The method of claim 2, wherein the catalyst is a base having a pH greater than or equal to 10.

4. The method of claim 2, wherein the catalyst is selected from the group consisting of Pt, Ru, and Ir.

5. The method of claim 1, wherein the semi-selective polymer matrix comprises a water-soluble polymer.

6. The method of claim 1, wherein the semi-selective polymer matrix comprises a polymer formed using N-vinylpyrrolidone or acrylic acid as a monomer.

7. The method of claim 1, wherein the highly conductive material of the sensing element of the electrochemical sensor is selected from the group consisting of Au, Pt, Ag, Cu, Ru, Ir, a dichromate, a phosphate, a perchlorate, and a permanganate.

8. The method of claim 1, further comprising:
comprising the measured resistance to a previously measured resistance or a predetermined threshold before determining whether the analyte was in the fluid.
